(19) United States
(12) Patent Application Publication
(10) Pub. No.: US 2006/0127716 A1
(43) Pub. Date: Jun. 15, 2006

(54) Fuel cell with fuel supply device and method for producing the same

(75) Inventor: Mirko Lehmann, Freiburg (DE)

Correspondence Address: Patrick J O'Shea;O'Shea Getz & Kosakowski, 1500 Main Street, Suite 912, Springfield, MA, 01115, US

(73) Assignee: Micronas GMBH, Freiburg (DE)

(21) Appl. No.: 10/536,462

(22) PCT Filed: Dec. 1, 2003
(86) PCT No.: PCT/EP03/13494

§ 371 Date: Dec. 5, 2005

(30) Foreign Application Priority Data
Nov. 29, 2002 (DE) 10255736.5

(51) Int. Cl. H01M 8/06; H01M 4/86; H01M 8/04

(52) U.S. Cl. 429/19; 429/40; 429/23

(57) ABSTRACT

The invention relates to a fuel cell with
a first electrode (3) and a second electrode (4), one of which is produced as the cathode and the other as the anode,
a layer (5) permeable at least to protons that has catalytic activity, or an additional catalytic material in the region between the first electrode (3) and the second electrode (4),
a fuel delivery device to feed in a fuel (H₂), and
a reactant delivery device to feed in a reactant (O₂) that reacts with protons from the fuel (H₂) to generate current, with the fuel delivery device and the reactant delivery device being positioned on the side of the first electrode and on the side of the second electrode, respectively.

To be able to provide structurally small fuel cells with a limited current capacity, it is proposed that the fuel (H₂) to generate a given amount of current be integrated into the material of an electrode designed as a fuel delivery device (3) and/or in a layer adjacent to it. Alternatively, the reactant can also be introduced correspondingly into a reactant delivery device of this type.

This invention relates to a fuel cell with a fuel delivery device according to the features of the preamble of claim 1, a circuit with an integrated fuel cell of this type, an electrically operated device with such a fuel cell, a method for manufacturing such a fuel cell, and a sensor device.

The electrical power for electrically operated devices, circuits, and the like, is ordinarily supplied by external energy sources. Typical external energy sources are connections to a power network, batteries, or storage batteries.

Fuel cell systems can also be used instead of batteries or storage batteries. Fuel cells ordinarily consist of a first electrode system and a second electrode system, one of which serves as an anode and the other as a cathode. Between the two electrode systems there is a membrane-electrode unit (MEU) with catalytic properties that serves as a proton-permeable membrane with catalytic coating. Such a fuel cell also has a fuel delivery device for feeding in a fuel, typically hydrogen, and a reactant delivery device for feeding in a reactant. The reactant reacts with protons that originate from the fuel and that have passed through the membrane, to generate current.

U.S. Pat. No. 6,312,846 B1 discloses a fuel cell that is formed on a semiconductor wafer, with channels being formed in the wafer as conductors for the fuel and for the reactant, and with a membrane being formed between the channels that permits the diffusion of protons. It is a drawback to such systems that an additional separate reservoir connected to the channel conducting the fuel has to be provided.

U.S. Pat. No. 6,326,097 B1 discloses a system designed to recharge the batteries, for example of a mobile radio. This system consists essentially of a mount with an electrical connection for the instrument to be provided with current and a fuel cell system to generate the current to be supplied, as well as a fuel delivery device to feed the fuel into the fuel cell system. The fuel delivery device in this case consists of a receptacle for hydrogen storage cartridges, which can be replaced after the fuel is consumed. Such systems are structurally complex and are reasonable for generating a rather large amount of current, as needed by mobile radios, for example.

Also generally known from U.S. Pat. No. 6,160,278 and WO 01/69228 A2 are hydrogen sensors that are fabricated as semiconductor structural units. Palladium (Pd) is used here as the hydrogen-sensitive electrode material.

The goal of this invention consists of providing a fuel cell with a fuel delivery device and/or a reactant delivery device that has a simple structure and is designed to provide a given amount of current, or the minimum amount required.

This goal is achieved by a fuel cell with a fuel delivery device according to the features of claim 1 and a method for manufacturing such a fuel cell with the features of claim 13. Such a fuel cell can advantageously be an integrated component of a circuit and/or of an electrically operated device according to the features of claims 6 or 8.

The starting point is a fuel cell with a first electrode and a second electrode, one of which is made as the cathode and the other as the anode, a layer with catalytic activity that is permeable to at least protons or additional catalytic material in the region between the first electrode and the second electrode, a fuel delivery device for the infeed of a fuel, and a reactant delivery device for the infeed of a reactant that reacts with protons from the fuel to generate current, with the fuel delivery device and the reactant delivery device being located on the side of the first electrode and on the side of the second electrode, respectively.

Using as the fuel delivery device a layer integrated into the fuel cell into which the fuel is already incorporated provides the benefit that no separate fuel infeed channels or the like have to be provided. This simplifies construction considerably.

According to an alternative embodiment, a fuel cell is provided with a reactant delivery device according to the features of claim 14.

It is advantageous also to provide sensor devices with the features of claim 25.

Advantageous refinements are the objects of dependent claims.

The fuel delivery device suitably consists of a material contacted by the fuel that releases the fuel or protons generated from it as needed. Palladium is preferably used as the base material for such a fuel delivery device because of its good hydrogen sensitivity, with hydrogen usually being used as the fuel for fuel cells at the present time.

The preferred reactant is oxygen, which can be fed in from the atmosphere. The reactant infeed device in the simplest case is therefore a channel or an open surface that communicates with the external space.

It is especially advantageous to use a control device to activate the fuel cell or a unit consisting of multiple coupled fuel cells of this type. Such a control device on the one hand can be a switch that closes a circuit between the two electrodes of the fuel cell. On the other hand, in a particularly preferred embodiment, a fuel cell can be provided in which the reactant delivery device consists of a space that has no reactant, or for example that is evacuated of ambient air. The control device, for example, can then consist of a window to this evacuated space that can be opened to permit the entry of ambient air and with it oxygen as the reactant, to the fuel cell or its corresponding reaction surface.

The control device, for example, can have a control element such as the switch or the partition to be opened, to trigger an alarm. Alarm devices of this type can be used in many ways, especially to signal a burglary or to signal an emergency for a handicapped person. The alarm signals can be emitted in the usual way, in particular by light signals, acoustic signals, or by radio transmission to an emergency control center. In the latter case, besides transmitting the actual emergency signal, it is desirable also to transmit personal data about the sender and preferably a current position determined, for example, by a GPS (global positioning system).

It is also possible to use such fuel cells as energy reservoirs for recharging electrically operated circuits or devices that consume only minimal current, so that connecting a battery or providing a fuel reservoir can be structurally omitted.

Such a fuel cell with a fuel delivery device can advantageously be integrated directly into a circuit. An advantageous area of use would be CMOS circuits. Use in appropriate electrically operated devices is also advantageous instead of using a battery. An example of such an electrically operated device can be an alarm system in which the fuel cell is replaced after single or multiple activations of an alarm.

Modular construction that permits replacement as a module after one or more uses is particularly advantageous. Such a module may consist of only a fuel cell with its fuel delivery device, but for example may also consist of a circuit with an integrated fuel cell. Such a module advantageously has connectors, for example plugs that can be inserted into corresponding sockets of a circuit or of an electrically operated device.

Connection of a fuel sensor, especially a hydrogen sensor, is also advantageous for such a fuel cell, with the fuel sensor being in contact with the layer that contains the fuel. A warning signal can be emitted by the fuel sensor in case of decreasing fuel content, which shows that the fuel cell has to be replaced.

Depending on the choice of parallel or series circuitry, coupling multiple fuel cells of this type makes it possible to increase the available current and/or voltage. In this case, multiple fuel cells can be placed on one chip face, and can be wired in parallel through a common multiplex cable.

Since such cells are structural units made of single pure materials, these fuel cells can also be easily recycled.

The above advantages are also obtained correspondingly for the case of a reactant delivery device. Ideally, such a fuel cell can also have both a fuel delivery device and a reactant delivery device.

Hydrogen is preferably considered as the fuel and oxygen as the reactant. However, any other fuels and appropriate reactants can also be used. In particular, the terms fuel and reactant should be interpreted broadly, with oxygen in the last analysis also to be viewed as the fuel and hydrogen as the associated reactant, for example.

Embodiments are also possible in which both the fuel and the reactant are provided in the electrodes or in materials adjacent to the electrodes.

Exemplary embodiments will be described below in further detail with reference to the drawings:

FIG. 1 shows a fuel cell with fuel delivery device on a base in simple form;

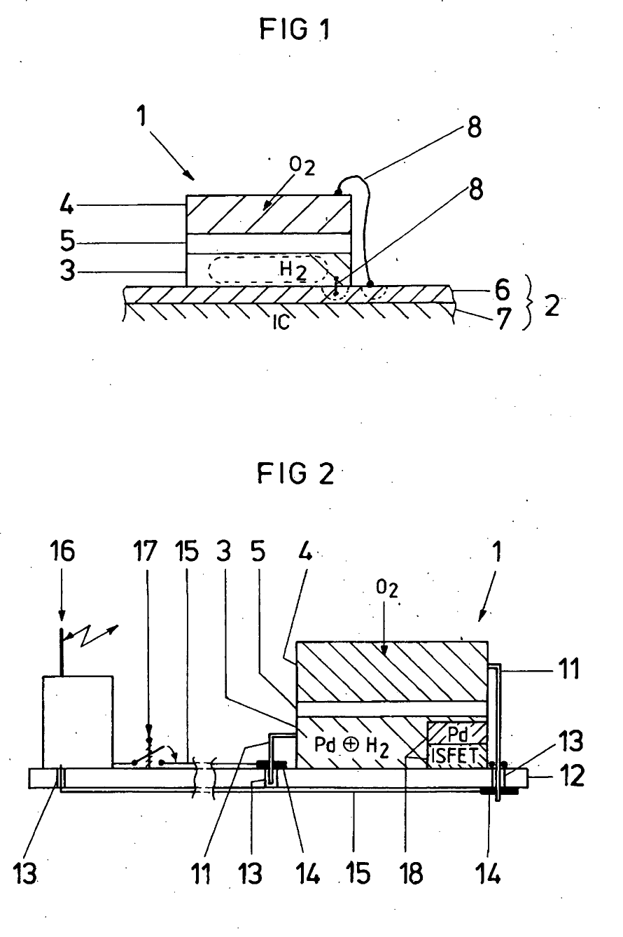

FIG. 2 shows a fuel cell in preferred embodiment in combination with a circuit,

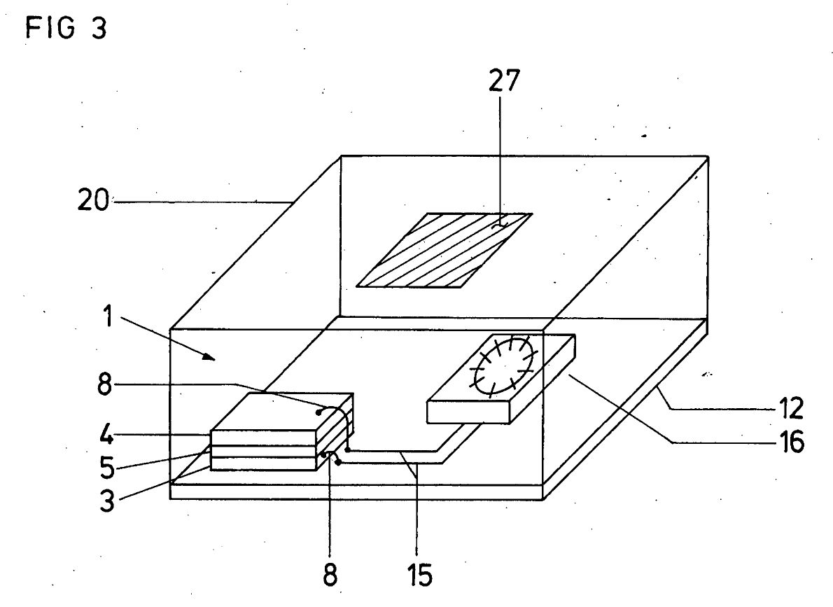

FIG. 3 shows another circuit arrangement with a fuel cell and a circuit in a reactant-free space,

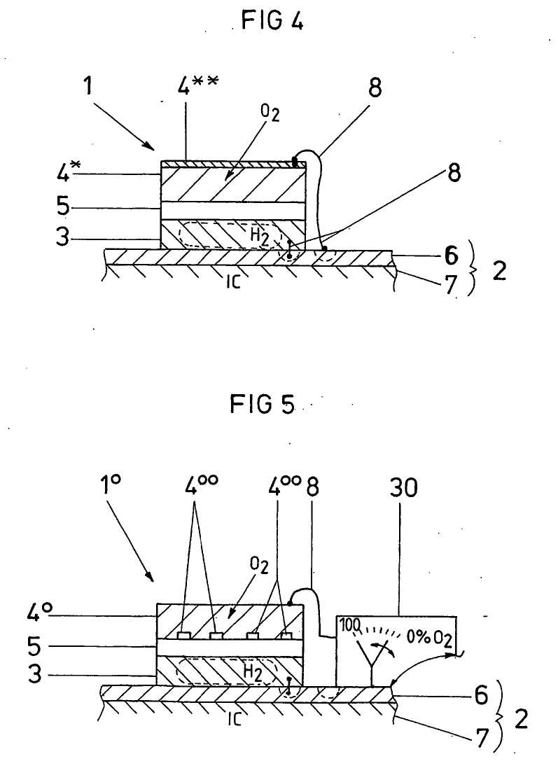

FIG. 4 shows an alternative embodiment with an alternative electrode structure, and

FIG. 5 shows another embodiment with yet another electrode structure and wiring as a sensor.

As FIG. 1 shows, a fuel cell consists essentially of a first electrode 3 and a second electrode 4 or appropriate electrode system. The two electrodes 3, 4 are formed at least by one proton-permeable layer 5, preferably in the form of a catalytic membrane. The electrodes 3, 4 are formed as anode and cathode, respectively, and have electrical connections 8. In the exemplary embodiment shown, the first electrode 3 is positioned directly on a base 2, so that a direct connection can be made to a corresponding conductive region of the base 2. A contact 8 is made in the form of a conductor line that leads from the second electrode 4 to the surface of the base 2, for example to connect the second electrode 4. The base 2 in an especially preferred embodiment consists on its top, i.e. facing the fuel cell 1, of a polysilicon 6 with appropriate structuring or design of appropriately doped regions. The polysilicon 6 constitutes a transition layer to an integrated circuit 7 (IC) located beneath it that is to be supplied with current from the fuel cell 1.

As is customary for fuel cells, fuel that preferably consists of hydrogen H₂ escapes from the face of the first electrode 3. The fuel reacts with the catalytic layer 5 or appropriate elements in the material of the first electrode 3 in such a way that hydrogen ions, i.e. protons, are released. These protons pass through the proton-permeable layer 5 toward the second electrode 4. In the region of the second electrode 4, the protons react with a reactant fed to this region, preferably oxygen O₂. When a circuit is closed between the electrical conductors 8, a corresponding current flows through them.

As FIG. 1 shows, the reactant O₂ arrives directly at the freely accessible second electrode 4 from the surroundings, so that with regard to the reactant operation is possible in any area with oxygen-containing air. In the embodiment shown, the second electrode 4 consists of a diffusion layer that permits the entry and passage of the reactant O₂.

The fuel delivery device advantageously consists directly of the first electrode 3 itself and/or another layer adjacent to it. This first electrode 3 or the other layer contains fuel, i.e. preferably hydrogen H₂. When needed, this fuel is released from the material of the first electrode 3, in a comparable manner to what is known otherwise from prior art fuel cells from corresponding fuel infeed channels.

Actually, at first glance such a system appears disadvantageous since only a limited amount of fuel is available, but the structural advantage of the capability of small size outweighs this, especially in devices with only very low and perhaps only a one-time current demand, since no additional fuel infeed channels or separate fuel reservoirs are necessary.

The manufacture of such a fuel cell with the integrated fuel delivery device is particularly simple in a semiconductor production process, for example in a CMOS process (CMOS: complementary symmetry metal-oxide semiconductor transistor). In this case a material treated by the fuel is applied to a base layer in the preparation of the layer to develop the first electrode 3 or the other layer adjacent to it. A combination of contacted palladium (Pd) that is treated with hydrogen during or after the deposition process is especially advantageous. The membrane or the proton-permeable layer 5 and other materials and layers necessary for a fuel cell are then applied.

For example a first electrode 3 consisting of a palladium layer with an area of 1 mm² and 1 μm thick can be saturated with hydrogen during the production process. The preferred objective with such a system is to manage with this hydrogen, in other words not to provide for any additional infeed devices for hydrogen or corresponding energy carriers. The oxygen is advantageously fed in from the atmosphere. According to initial calculations, a current of 1 μA lasting ten seconds can be generated by a single treatment with hydrogen in the example described. Simple semiconductor circuits or chips can be provided with an integrated power source in this way, for example to make an alarm system.

Thus, use for circuits and devices to be used preferably in emergencies is particular advantageous. A system for this purpose is shown in FIG. 2 by way of example.

FIG. 2 shows that not only the integrated system of a fuel cell 1 with a base 2 described above is possible, but also a modular system of a replaceable fuel cell 1 that can be plugged into a base 12. The fuel cell 1 in this case again consists essentially of the structure described above, so that comparable structural elements need not be discussed again.

Electrical conductors that are preferably located on the sides of the electrodes 3, 4 in the illustrated exemplary embodiment and are designed as contact pins 11, again serve to connect the first and second electrodes 3, 4. These contact pins 111 lead downward toward the base 12 made as a bottom plate, and pass into and through this base 12 through contact pin receptacles or holes 13. Contacts 14 that make contact between corresponding electrical conductors 15 on or in the base 12 and the contact pins 11 are present in the area of each hole 13. The holes 13 and/or the contacts 14 are of such dimensions and/or are provided with such material that they offer enough support for the contact pins 11 so that the fuel cell 1 can be positioned removably but sufficiently firmly on the base 12 through the contact pins 11.

In the exemplary embodiment illustrated, the fuel cell 1 serves to supply current to a circuit 16, which is likewise placed on the base 12. The circuit 16 here is supplied with current through the two electrical conductors 15. One of the two conductors 15 leads in this case through a switching device 17, which can be designed as a simple pushbutton. However, any other form of switching device, in particular light sensor switches, switching devices reacting to acoustic signals, motion detectors, and the like, is also possible as a switch. After activation of the switching device 17, the circuit is closed and the electrochemical process in the fuel cell is activated to supply the circuit 16. Hydrogen H₂ that is present in the material of the first electrode 3 or in a layer adjacent to it is cleaved, and protons pass through the proton-permeable layer 5 to the second electrode 4, where a reaction with oxygen O₂ from the atmosphere takes place, with current being generated.

If the circuit 16 is an alarm system for example, then an alarm can be triggered by the activation of the switching device 17, for example by sounding a warning tone, a light signal, or by transmitting an electromagnetic signal through a radio interface or a wired interface to a receiver, for example in an emergency center.

In addition to the warning information, such a signal can also transmit coded information about the transmitter or its holder, or place of installation, and preferably also position data when used as a portable warning device. Current position information can be provided, for example, by coupling with a GPS receiver.

Alternatively to fastening the fuel cell on the base 12 through the contact pins 11, additional or different fasteners can also be provided. In particular, it is also possible to fasten the fuel cell 1 to biosensors and the like.

The system advantageously also has a fuel sensor 18, preferably a hydrogen sensor, to determine the content or residual content of fuel in the first electrode 3 or in a layer adjacent to it, or both. Such a fuel sensor 18 consists, for example, of an ISFET (ion-selective field effect transistor) with an applied palladium Pd layer or a palladium resistor. This fuel cell sensor 18 is connected by appropriate leads to other circuit components that serve to signal fuel depletion, so that the fuel cell can be replaced as needed.

Instead of such a fuel cell sensor 18 or in addition to it, however, a circuit that measures the resistance of the fuel delivery device and compares the measurement with test measurements made previously can also be used to determine the remaining fuel.

Another exemplary embodiment is shown in FIG. 3. Elements that are structurally identical or equivalent with reference to the above exemplary embodiments are not mentioned again. In essence, the embodiment has a base 12 on which are mounted a fuel cell 1 with a first electrode 3 containing fuel, a proton-permeable layer 5, and a second electrode 4. Electrical conductors 8, 15 lead from the fuel cell 1 to a circuit 16, likewise positioned on the base 12. This can be either an alarm system, a sensor, a storage device, or the like, for example. In contrast to the second exemplary embodiment, this system does not have an ordinary switching device that disconnects at least one of the two electrical conductors 15 in the normal state. Instead, the entire system is in a housing 20 whose internal space is free of the reactant necessary for generating current. In the usual example, there would be no oxygen inside the housing 20. To activate the generation of current, there is a region that is closed off in normal operation inside one of the walls of the housing 20, which serves as a switching device 27. By opening this closed-off region, preferably by a film that can be pierced or a valve to be opened, atmospheric air and thus oxygen enters the internal space of the housing 20. This leads to activation of the electrochemical process and thus to a flow of current through the circuit 16. According to an especially preferred form of embodiment, the internal space of the housing 20 is evacuated, so that when the switching device 27 is opened all at once or by using the controllable valve in a controlled manner, atmospheric air enters the previously evacuated internal space of the housing 20. Activation of current generation can be hastened by this.

In the simplest form of embodiment, however, the switching device 27 can also consist of a removable housing or a peelable film that can be formed around the entire system or only around the second electrode 4 or the region in which the reactant can react with the protons.

FIG. 4 illustrates an alternative electrode system. Instead of a one-piece electrode 4 consisting of a diffusion layer, the electrode consists of multiple parts, a diffusion layer 4* and an actual electrode covering 4**. The electrode covering 4** consists of a solid electrically conductive material and serves to feed in current or to divert it. The diffusion layer 4* allows the reactant O₂ to enter from the side or appropriate openings in the electrode covering 4**.

FIG. 5 illustrates another electrode system. The entire electrode 4^{o} consists of a material that is a good electrical conductor, but which does not allow the passage of the reactant O₂, or allows it only inadequately. Reactant channels 4^{o} or other passages in the electrode serve to feed the reactant O₂ to the membrane-electrode unit 5 (MEU) with catalytic properties. The reactant channels 4^{oo} are preferably formed adjacent to the membrane-electrode unit 5.

Only structural elements relevant to the principal mode of operation are outlined in the illustrated exemplary embodiments. Other functionally necessary structural elements are to be used in accordance with the knowledge of the individual skilled in the art. For example, a coating that insulates from the reactant can be formed around the lower region of the fuel cell so that access of reactant from the atmosphere to the first electrode can be prevented.

While the above exemplary embodiments are described with a layer delivering the fuel, a layer that delivers the reactant can be formed in addition or alternatively in a corresponding manner, with the fuel then being fed in from the outside.

The structure for this is then essentially as described above. Instead of the fuel, in the present case hydrogen H₂, the reactant, in the present case in particular oxygen O₂, is then introduced into a layer. Appropriately, the reaction region and any region present with a layer that contains fuel is shielded so that no other reactant can penetrate from the outside and trigger the current-producing process.

Accordingly, the fuel is then fed in from the outside for operation. In case of a combined method with a layer that feeds in the fuel and one that feeds in reactant, an appropriate switching device is made available that begins the electrochemical reaction after actuation and makes current available.

Such a fuel cell can also be used advantageously as a sensor to determine the amount of reactant available in the surroundings. As FIG. 5 shows, the strength of the current generated by the fuel cell is measured, for example, by a measuring device 30. The current is in a direct ratio to the amount of reactant that reaches the fuel cell from the surroundings.

Sensors can thus be used to determine the quantity of a reactant in the surroundings of the fuel cell by determining the amount of current or the voltage of the current generated, and displaying or interpreting this.

Such a sensor can be used not only to indicate a given condition of the surroundings. Naturally, hydrogen can also be considered to be a reactant, with the function of fuel then being taken over by oxygen.

For example, the sensor can also be used as a warning device, for example to warn of gases containing carbon that do not ordinarily occur in this environment or should not occur for safety reasons. The use of the described layers with integrated fuel or reactant is particularly advantageous in such warning devices. In the usual case, for example, an alarm needs to be triggered only in the emergency of a gas leak. Such warning devices equipped with an external fuel infeed would by uneconomical for this reason. Such a sensor with the integrated reactant or fuel for a limited operating time can thus be used to advantage, especially in areas in which current or fuel is needed only rarely, or never in the normal case.

However, such sensors can also be used advantageously in combination with an external fuel or reactant infeed device. A sensor to which the fuel or the reactant is fed continuously through a rechargeable or replaceable gas cartridge or through a fixed installed line can be used to great advantage to measure correspondingly the reactant or the fuel in the surroundings. On the one hand, this infeed device can make permanent operation possible as a sensor. On the other hand, it can also be assured that the infeed of fuel or reactant occurs continuously so that variations are avoided, and conclusions can be drawn about the intensity of the reactant or the fuel in the surroundings from variations of the measured current strength or voltage, directly and without a second variable parameter.

1. Fuel cell with
a first electrode (3) and a second electrode (4), one of which is formed as the cathode and the other as the anode,
a layer (5) that is permeable at least to protons, with catalytic activity or an additional catalytic material in the region between the first electrode (3) and the second electrode (4),
a fuel delivery device to provide a fuel (H₂), and
a reactant delivery device to provide a reactant (O₂), which reacts with protons from the fuel (H₂) to generate current, with the fuel delivery device and the reactant delivery device being positioned on the side of the first electrode and on the side of the second electrode, respectively,
where
the fuel (H₂) is integrated into the material of one of the electrodes (3) formed as the fuel delivery device (3) and/or of a layer adjacent to it.

2. Fuel cell according to claim 1 in which the fuel delivery device (3) comprises a contacted material that is treated with the fuel.

3. Fuel cell according to claim 1 in which the fuel delivery device (3) comprises palladium (Pd).

4. Fuel cell according to claim 1 in which hydrogen (H₂) is integrated into the fuel delivery device (3) as the fuel.

5. Fuel cell according to claim 1 in which the reactant infeed device for the infeed of the reactant (O₂) comprises the space surrounding at least the second electrode or the space surrounding the reaction region.

6. The fuel cell of claim 1 comprising an electrical circuit (7; 16).

7. The fuel cell of claim 6, where the electrical circuit comprises a CMOS circuit.

8. The fuel cell of claim 1 comprising:
a control device (17; 27) for controlling a current flow or an energy infeed.

9. The fuel cell of claim 1, comprising:
a control device (17; 27) to activate the electrochemical reaction in the fuel cell (1) or to complete the electrical circuit through the electrodes (3, 4) of the fuel cell (1).

10. The fuel cell of claim 9 in which the control device (27) comprises a closed closure device, wherein the space around the reaction region of the reactant (O₂) has no reactant and wherein reactant from external space enters the reaction region by opening the closure device (27).

11. The fuel cell of claim 1, where at least the fuel cell being designed as a replaceable module.

12. The fuel cell of claim 1, comprising:
a fuel sensor (18) that is positioned in the fuel delivery device (3) and/or in the reaction region between the protons and the reactant, to determine the available or current amount of fuel.

13. Method for manufacturing a fuel cell in which a first electrode (3), a second electrode (4), and a proton-permeable layer (5) with catalytic activity separating them are produced, or in addition to the layer (5) a catalytic material is produced between the electrodes (3, 4),
characterized in that
a fuel delivery device is produced as an integral part of one of the electrodes (3) or as a layer adjacent to it, with the material of the fuel delivery device being treated with fuel during its preparation or thereafter.

14. A fuel cell, comprising:
a first electrode (3) and a second electrode (4), one of which is formed as the cathode and the other as the anode,
a layer (5) that is permeable at least to protons, with catalytic activity or an additional catalytic material in the region between the first electrode (3) and the second electrode (4),
a fuel delivery device to provide a fuel (H₂), and
a reactant delivery device to provide a reactant (O₂), which reacts with protons from the fuel (H₂) to generate current, with the fuel delivery device and the reactant delivery device being positioned on the side of the first electrode and on the side of the second electrode, respectively,
where
the reactant (O₂) for generating a given amount of current is integrated into the material of one of the electrodes produced as a reactant delivery device (3) and/or in a layer adjacent to it,
and the fuel cell is designed so that only reactant from this reactant delivery device can react with the fuel.

15. Fuel cell according to claim 14 in which the reactant delivery device (3) comprises a contacted material that is treated with the reactant.

16. Fuel cell according to claim 14 in which oxygen (O₂) is integrated into the reactant delivery device.

17. The fuel cell of claim 14 further comprising an CMOS electrical circuit (7; 16).

18. The fuel ecll of claim 17 further comprising:
a control device (17; 27) for controlling a flow of current or an infeed of energy.

19. The fuel cell of claim 17 further comprising,
a control device (17; 27) for activating the electrochemical reaction in the fuel cell (1) or for completing the electrical circuit through the electrodes (3, 4) of the fuel cell (1).

20. The fuel cell according to claim 19 in which the control device (27) comprises a closed closure device, wherein the space around the reaction region of the fuel with the reactant (O₂) has no fuel, and wherein fuel from the external space enters the reaction region by opening the closure device (27).

21. The fuel cell of claim 17 wherein at least the fuel cell is configured as a replaceable module.

22. The fuel cell of claim 21, comprising:
a reactant sensor (18) that is positioned in the reactant delivery device (3) and/or in the reaction region between the protons and the reactant, to determine the available or current amount of reactant.

23. The fuel cell of claim 21, comprising:
a circuit for measuring the resistance of the fuel delivery device or of the reactant delivery device (3), for determining the remaining amount of fuel or of reactant.

24. Method for manufacturing a fuel cell in which a first electrode (3), a second electrode (4), and a proton-permeable layer (5) with catalytic activity separating them are produced, or in addition to the layer (5) a catalytic material is produced between the electrodes (3, 4),
characterized in that
a reactant delivery device is produced as an integral part of one of the electrodes (3) or as a layer adjacent to it, with the material of the reactant delivery device being treated with reactant during its preparation or thereafter.

25. The fuel cell of claim 21, comprising:
a measuring device (30) for determining the strength of the current or the voltage generated by the fuel cell as a measured variable parameter for the fuel or reactant (O₂).
